(19) United States
(12) Patent Application Publication
(10) Pub. No.: US 2025/0378464 A1
(43) Pub. Date: Dec. 11, 2025

(54) SYSTEM OF MATCHING DIGITAL WAX MUSEUM WITH MARKETING ADVERTISEMENT BASED ON METAVERSE AND METHOD THEREOF

(71) Applicants: SQ Technology (Shanghai) Corporation, Shanghai (CN); Inventec Corporation, Taipei (TW)

(72) Inventor: Chuan-Cheng CHIU, Shanghai (CN)

(73) Assignees: SQ Technology (Shanghai) Corporation, Shanghai (CN); Inventec Corporation, Taipei (TW)

(21) Appl. No.: 18/822,231

(22) Filed: Sep. 1, 2024

(30) Foreign Application Priority Data
Jun. 6, 2024 (CN) 202410733427.6

(51) Int. Cl. G06Q 30/0241; G06F 16/951; G06T 13/40

(52) U.S. Cl. CPC G06Q 30/0241; G06F 16/951; G06T 13/40

(57) ABSTRACT

A system of matching digital wax museum with marketing advertisement based on metaverse and a method thereof are disclosed. In the system, a display device displays a virtual scene, and a virtual wax statue and a virtual avatar of a consumer, and a server connected to the display device executes a digital wax museum platform and serves as a node of a blockchain network. The server generates a virtual wax statue and a virtual scene and allows the consumer to select the virtual wax statue and the virtual scene, input an interaction level, to make the virtual avatar perform an interaction with the virtual wax statue in the virtual scene based on interaction level. A charging amount and a profit-sharing amount are calculated through a smart contract of the blockchain technology. Therefore, the technical effect of improving the interactivity and economic efficiency for marketing can be achieved.

### BACKGROUND OF THE INVENTION

### 1. Field of the Invention

The present invention relates to a marketing system and a method thereof, and more particularly to a system of matching digital wax museum with marketing advertisement based on metaverse and a method thereof.

### 2. Description of the Related Art

In recent years, with the vigorous development of the metaverse, various applications of the Metaverse have sprung up. For example, the metaverse and marketing are combined to provide consumers and users with immersing experience.

Generally, the conventional marketing methods include print advertising and Internet advertising. However, using these marketing methods is gradually unable to meet the ever-changing needs of consumers. In view of this, some manufacturers have proposed virtual reality technology to provide immersive experience for attracting consumers. However, simply using virtual reality for marketing is only different from conventional marketing methods in the way of presentation and cannot effectively improve the interactivity and economic benefits of marketing.

According to above-mentioned contents, what is needed is to develop an improved solution to solve the conventional problem of insufficient interactivity and poor economic benefits in marketing.

### SUMMARY OF THE INVENTION

An objective of the present invention is to disclose a system of matching digital wax museum with marketing advertisement based on metaverse and a method thereof.

To achieve the objective, the present invention discloses a system of matching digital wax museum with marketing advertisement based on metaverse, the system includes a display device and a server. After a consumer logs in a digital wax museum platform, the display device is configured to display at least one virtual scene, at least one virtual wax statue, and a virtual avatar of the consumer. The server is connected to the display device and configured to perform the digital wax museum platform and serve as one of nodes of a blockchain network, wherein the server includes a non-transitory computer-readable storage medium and a hardware processor. The non-transitory computer-readable storage medium is configured to store computer readable instructions. The hardware processor is electrically connected to the non-transitory computer-readable storage medium and configured to execute the computer readable instructions to make the hardware processor execute: generating the virtual wax statue through virtual imaging technology based on portrait data of a celebrity, and generating the virtual scene based on scene data; allowing to select the generated virtual wax statue and the virtual scene, and receiving an interaction level, and making the virtual avatar perform an interaction with the selected virtual wax statue based on the received interaction level, wherein the interaction level comprises levels and at least one action corresponding to the levels; building a genesis block to form a first block of the blockchain network based on a blockchain technology, connecting the first block to remote devices, which serve as the nodes of the blockchain network, to collectively execute a blockchain consensus mechanism to execute the blockchain network; deploying a smart contract in the blockchain network, wherein the smart contract comprises a charging function and a profit-sharing function, when the charging function is executed, a charging amount is calculated based on the received interaction level, selected virtual wax statue and the selected virtual scene, wherein when the profit-sharing function is executed, a profit-sharing amount is calculated based on the calculated charging amount and a profit-sharing ratio.

To achieve the objective, the present invention discloses a method of matching digital

wax museum with marketing advertisement based on metaverse, and the method is applied to environment where a display device and a server are disposed, wherein the server performs a digital wax museum platform and serves as one of nodes of a blockchain network, and the method includes steps of: generating at least one virtual wax statue through virtual imaging technology based on portrait data of a celebrity, and generating the at least one virtual scene based on scene data, by the server; after detecting a consumer to log in the digital wax museum platform, driving the display device to display the virtual scene, the virtual wax statue, and a virtual avatar of the consumer, by the server; allowing to select the generated virtual wax statue and the virtual scene, and receiving an interaction level, and making the virtual avatar to perform an interaction with the selected virtual wax statue based on the received interaction level, by the server, wherein the interaction level comprises levels and at least one action corresponding to the levels; building a genesis block to form a first block of the blockchain network based on a blockchain technology, connecting the first block to remote devices which serve as nodes of the blockchain network, to collectively execute blockchain consensus mechanism to execute the blockchain network; deploying a smart contract in the blockchain network, by the server, wherein the smart contract comprises a charging function and a profit-sharing function, and when the charging function is executed, a charging amount is calculated based on the received interaction level, selected virtual wax statue and the virtual scene, wherein when the profit-sharing function is executed, a profit-sharing amount is calculated based on the calculated charging amount and a profit-sharing ratio.

According to the above-mentioned system and method of the present invention, the difference between the present invention and conventional technology is that, in the present invention, the display device displays the virtual scene, the virtual wax statue and the virtual avatar of the consumer, and the server connected to the display device executes the digital wax museum platform and serves as a node of the blockchain network. The server generates a virtual wax statue and a virtual scene and allows the consumer to select the virtual wax statue and the virtual scene, input the interaction level, make the virtual avatar perform an interaction with the virtual wax statue in the virtual scene based on interaction level. The charging amount and the profit-sharing amount are calculated through the smart contract of the blockchain technology.

Therefore, the technical effect of improving the interactivity and economic efficiency for marketing can be achieved.

### BRIEF DESCRIPTION OF THE DRAWINGS

The structure, operating principle and effects of the present invention will be described in detail by way of various embodiments which are illustrated in the accompanying drawings.

FIG. 1 is a system block diagram of a system of matching digital wax museum with marketing advertisement based on metaverse, according to the present invention.

FIG. 2A and FIG. 2B are flowcharts of a method of matching digital wax museum with marketing advertisement based on metaverse, according to the present invention.

FIG. 3 is a schematic view of a digital wax museum platform, according to an application of the present invention.

FIG. 4 is a schematic view of an interaction between a virtual avatar of a consumer and a virtual wax statue, according to an application of the present invention.

FIG. 5 is a schematic view of an operation of adjusting an interaction level, according to an application of the present invention.

### DETAILED DESCRIPTION OF THE PREFERRED EMBODIMENTS

The following embodiments of the present invention are herein described in detail with reference to the accompanying drawings. These drawings show specific examples of the embodiments of the present invention. These embodiments are provided so that this disclosure will be thorough and complete, and will fully convey the scope of the invention to those skilled in the art. It is to be acknowledged that these embodiments are exemplary implementations and are not to be construed as limiting the scope of the present invention in any way. Further modifications to the disclosed embodiments, as well as other embodiments, are also included within the scope of the appended claims.

These embodiments are provided so that this disclosure is thorough and complete, and fully conveys the inventive concept to those skilled in the art. Regarding the drawings, the relative proportions, and ratios of elements in the drawings may be exaggerated or diminished in size for the sake of clarity and convenience. Such arbitrary proportions are only illustrative and not limiting in any way. The same reference numbers are used in the drawings and description to refer to the same or like parts. As used herein, the singular forms “a”, “an” and “the” are intended to include the plural forms as well, unless the context clearly indicates otherwise.

It is to be acknowledged that, although the terms ‘first,’ ‘second,’ ‘third,’ and so on, may be used herein to describe various elements, these elements should not be limited by these terms. These terms are used only for the purpose of distinguishing one component from another component. Thus, a first element discussed herein could be termed a second element without altering the description of the present disclosure. As used herein, the term “or” includes any and all combinations of one or more of the associated listed items.

It will be acknowledged that when an element or layer is referred to as being “on,” “connected to” or “coupled to” another element or layer, it can be directly on, connected or coupled to the other element or layer, or intervening elements or layers may be present. In contrast, when an element is referred to as being “directly on,” “directly connected to” or “directly coupled to” another element or layer, there are no intervening elements or layers present.

In addition, unless explicitly described to the contrary, the words “comprise” and “include,” and variations such as “comprises,” “comprising,” “includes,” or “including,” will be acknowledged to imply the inclusion of stated elements but not the exclusion of any other elements.

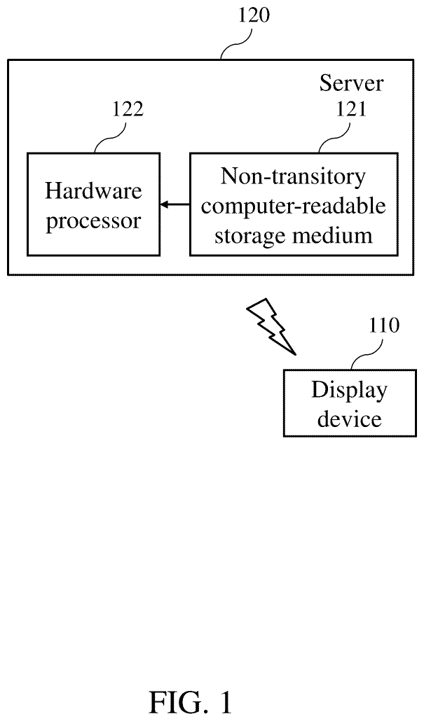

Please refer to FIG. 1. FIG. 1 is a system block diagram of a system of matching digital wax museum with marketing advertisement based on metaverse, according to the present invention. As shown in FIG. 1, the system includes a display device 110 and a server 120. After a consumer logs in the digital wax museum platform, the display device 110 displays a virtual scene, a virtual wax statue, and a virtual avatar of the consumer. In actual implementation, the virtual avatar of the consumer can be one of a dynamic image, a static image, a 2D image or a 3D image. In actual implementation, the display device 110 can be implemented by a head-mounted display (HMD), a naked-view 3D display device, or the like; however, the type of the display device 110 in the present invention is not limited, and any 3D display device can be used in the application field of the present invention.

The server 120 is connected to the display device 110 and configured to perform the digital wax museum platform and serve as a node of a blockchain network. The server 120 includes a non-transitory computer-readable storage medium 121 and a hardware processor 122.

The non-transitory computer-readable storage medium 121 is configured to store the computer readable instructions. In actual implementation, the non-transitory computer-readable storage medium 121 may include a hard disk, an optical disk, a flash memory, or the like. The computer readable instructions are executed by the server 120 and can be assembly language instructions, instruction-set-structure instructions, machine instructions, machine-related Instructions, micro-instructions, firmware instructions, or source codes or object codes written in any combination of one or more programming languages. The programming language includes object-oriented programming languages, such as: Common Lisp, Python, C++, Objective-C, Smalltalk, Delphi, Java, Swift, C#, Perl, Ruby, or PHP; the programming language can include regular procedural programming languages, such as C language or similar programming languages. In actual implementation, the server-end device 120 can be a rack server a tower server, a cloud server, a cluster server, or the like.

The hardware processor 122 is electrically connected to the non-transitory computer-readable storage medium 121 and configured to execute the computer readable instruction to make the hardware processor 122 to perform the following operations. The hardware processor 122 can generate a virtual wax statue based on portrait data of a celebrity through virtual imaging technology, generate the virtual scene based on scene data, allow to select the generated virtual wax statue and the generated virtual scene, receive an interaction level, and make the virtual avatar perform an interaction with the selected virtual wax statue based on the received interaction level. The interaction level includes levels and action corresponding to the levels. The hardware processor 122 can build a genesis block to form a first block of the blockchain network based on a blockchain technology, connect the first block to remote devices, which serve as nodes of the blockchain network, to collectively execute a blockchain consensus mechanism (such as a proof of work, a proof of equity, or a proof of delegated equity) to execute the blockchain network. The hardware processor 122 can deploy a smart contract in the blockchain network, the smart contract includes a charging function and a profit-sharing function; when the charging function is executed, a charging amount is calculated based on the received interaction level, selected virtual wax statue and the virtual scene; when the profit-sharing function is executed, a profit-sharing amount is calculated based on the calculated charging amount and a profit-sharing ratio. In actual implementation, the virtual wax statue includes at least one of a static virtual wax statue and a dynamic virtual wax statue, and the interaction between the virtual avatar and the selected virtual wax statue is generated by inputting the virtual avatar and the selected virtual wax statue to a generative AI model trained completely in advance, and outputting an interaction result from the generative AI model. The interaction result can be dynamically adjusted based on a prompt inputted to the generative AI model; for example, when the prompt is “hug”, then the outputted interaction result is adjusted to make the virtual avatar and the virtual wax statue present a hugging posture;

when the prompt is “handshake”, the outputted interaction result is adjusted to make the virtual avatar and virtual wax statue present a handshaking posture. The hardware processor 122 can perform a model establishment based on the interaction result in response to the virtual avatar and the selected virtual wax statue and print out a 3D doll based on a model establishment result through a 3D printer. In addition, the hardware processor is configured to execute a web crawler (also called spider) to obtain the portrait data and the scene data, from at least one of a license database and internet, as training data to be inputted to the generative AI model. The license database means a database storing licensed materials of portrait, scene image, and design drawing. In actual implementation, the action of the interaction level includes at least one of hand movement, facial movement and body movement of different intimacy level, the level is positively correlated to the intimacy level of action, for example, the higher level means higher intimacy level, and lower level means lower intimacy level. When the intimacy level becomes higher, the more intimate posture is allowed during interaction, vice versa. The corresponding action can be, in an order from low to high intimacy level, holding hands, hugs, kisses.

It is particularly to be noted that, in actual implementation, the present invention can be implemented fully or partly based on hardware, for example, one or more component of the system can be implemented by hardware processor such as integrated circuit chip, system on chip (SOC), a complex programmable logic device (CPLD), or a field programmable gate array (FPGA). The concept of the present invention can be implemented by a system, a method and/or a computer program. The non-transitory computer-readable storage medium records computer readable instructions, and the processor can execute the computer readable instructions to implement concepts of the present invention. The non-transitory computer-readable storage medium can be a tangible apparatus for holding and storing the instructions executable of an instruction executing apparatus. The non-transitory computer-readable storage medium can be, but not limited to electronic storage apparatus, magnetic storage apparatus, optical storage apparatus, electromagnetic storage apparatus, semiconductor storage apparatus, or any appropriate combination thereof. More particularly, the non-transitory computer-readable storage medium can include a hard disk, an RAM memory, a read-only-memory, a flash memory, an optical disk, a floppy disc, or any appropriate combination thereof, but this exemplary list is not an exhaustive list. The non-transitory computer-readable storage medium is not interpreted as the instantaneous signal such a radio wave or other freely propagating electromagnetic wave, or electromagnetic wave propagated through waveguide, or other transmission medium (such as optical signal transmitted through fiber cable), or electric signal transmitted through electric wire. Furthermore, the computer readable program instruction can be downloaded from the computer-readable storage medium to each calculating/processing apparatus, or downloaded through network, such as internet network, local area network, wide area network and/or wireless network, to external computer equipment or external storage apparatus. The network includes copper transmission cable, fiber transmission, wireless transmission, router, firewall, switch, hub, and/or gateway. The network card or network interface of each calculating/processing apparatus can receive the computer readable program instructions from network and forward the computer readable program instruction to store in non-transitory computer-readable storage medium of each calculating/processing apparatus.

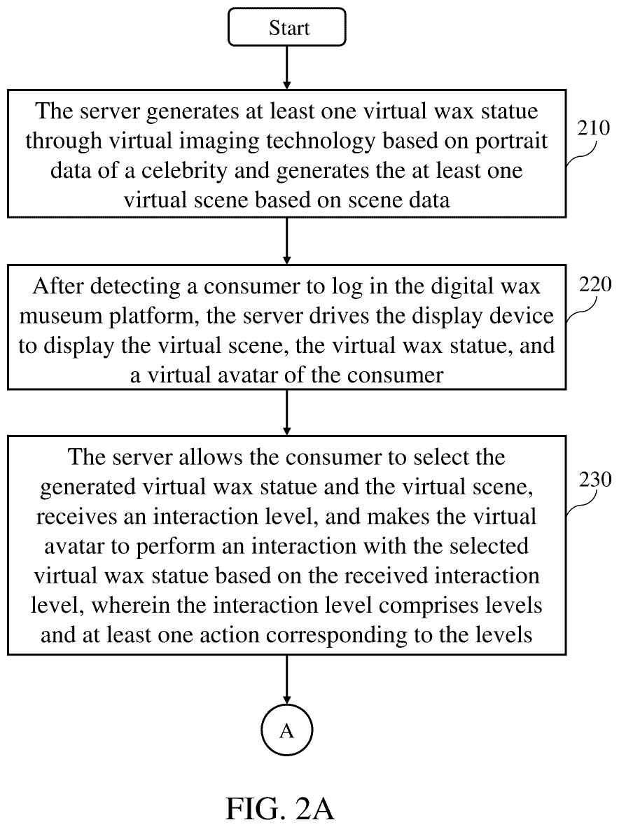

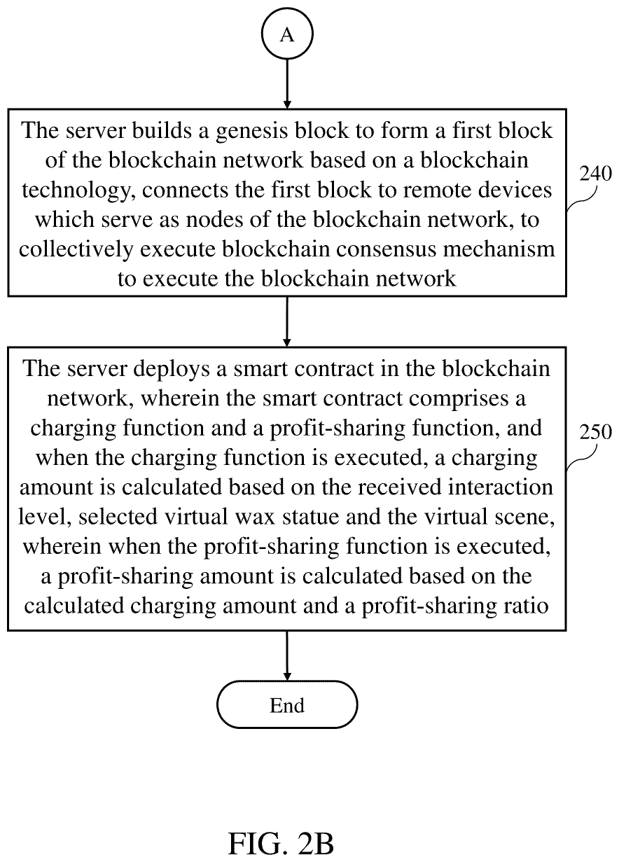

Please refer to FIG. 2A and FIG. 2B. FIG. 2A and FIG. 2B are flowcharts of a method of matching digital wax museum with marketing advertisement based on metaverse, according to the present invention. The method is applied to environment where the display device 110 and the server 120 are disposed, and the server 120 performs a digital wax museum platform and serves as a node of a blockchain network. The method includes the following steps. In a step 210, the server 120 generates at least one virtual wax statue through virtual imaging technology based on portrait data of a celebrity and generates the at least one virtual scene based on scene data. In a step 220, after detecting a consumer to log in the digital wax museum platform, the server 120 drives the display device 110 to display the virtual scene, the virtual wax statue, and a virtual avatar of the consumer. In a step 230, the server 120 allows the consumer to select the generated virtual wax statue and the virtual scene, receives an interaction level, and makes the virtual avatar to perform an interaction with the selected virtual wax statue based on the received interaction level, wherein the interaction level comprises levels and at least one action corresponding to the levels. In a step 240, the server 120 builds a genesis block to form a first block of the blockchain network based on a blockchain technology, connects the first block to remote devices which serve as nodes of the blockchain network, to collectively execute blockchain consensus mechanism to execute the blockchain network. In a step 250, the server 120 deploys a smart contract in the blockchain network, wherein the smart contract comprises a charging function and a profit-sharing function, and when the charging function is executed, a charging amount is calculated based on the received interaction level, selected virtual wax statue and the virtual scene, wherein when the profit-sharing function is executed, a profit-sharing amount is calculated based on the calculated charging amount and a profit-sharing ratio. Through aforementioned steps, the display device 110 can display the virtual scene, the virtual wax statue and the virtual avatar of the consumer, and the server 120 connected to the display device 110 executes the digital wax museum platform and serves as a node of the blockchain network. The server 120 generates a virtual wax statue and a virtual scene and allows the consumer to select the virtual wax statue and the virtual scene, input the interaction level, make the virtual avatar perform an interaction with the virtual wax statue in the virtual scene based on interaction level. The charging amount and the profit-sharing amount are calculated through the smart contract of the blockchain technology.

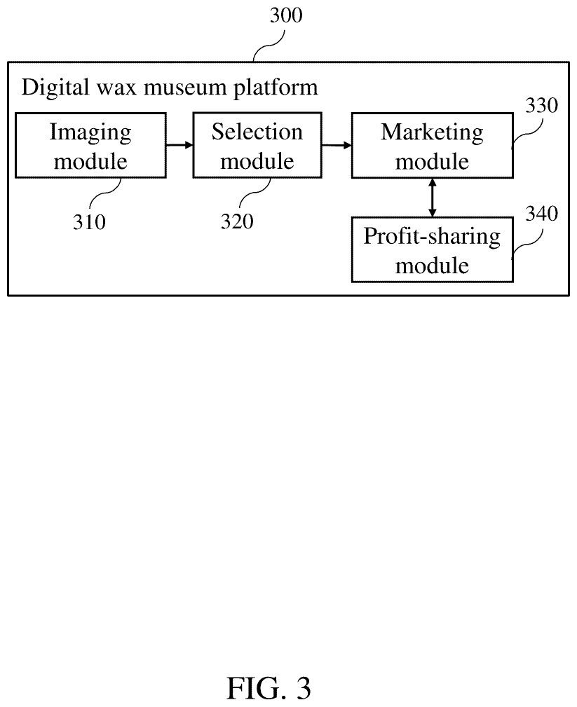

An embodiment of the present invention will be illustrated with reference to FIG. 3 to FIG. 5. Please refer FIG. 3. FIG. 3 is a schematic view of a digital wax museum platform, according to an application of the present invention. In actual implementation, besides the system block diagram shown in FIG. 1, the server 120 of FIG. 1 can also execute a digital wax museum platform 300, and the digital wax museum platform 300 includes an imaging module 310, a selection module 320, a marketing module 330, and a profit-sharing module 340. The imaging module 310 generates a virtual wax statue based on pre-stored portrait data, through virtual imaging technology and generate a virtual scene based on pre-stored scene data. For example, the virtual imaging technology includes virtual reality, augmented reality, mixed reality, or stereoscopic imaging technology. The selection module 320 is connected to the imaging module 310 and configured to permit a consumer to freely select the generated virtual wax statue and virtual scene through a virtual reality apparatus and receive an interaction level. The marketing module 330 is connected to the selection module 320 and configured to make the virtual avatar perform an interaction with the selected virtual wax statue based on interaction level, to achieve marketing purpose. The interaction level includes levels and actions corresponding to the levels. The profit-sharing module 340 is connected to the marketing module 330 on a basis of blockchain technology and configured to execute a smart contract to calculate a charging amount and a profit-sharing amount based on the interaction level, the selected virtual wax statue, and the virtual scene. Particularly, the above-mentioned modules are differentiated by functions thereof, the functions can be implemented by different computer readable instructions, and the hardware processor is configured to execute the computer readable instructions.

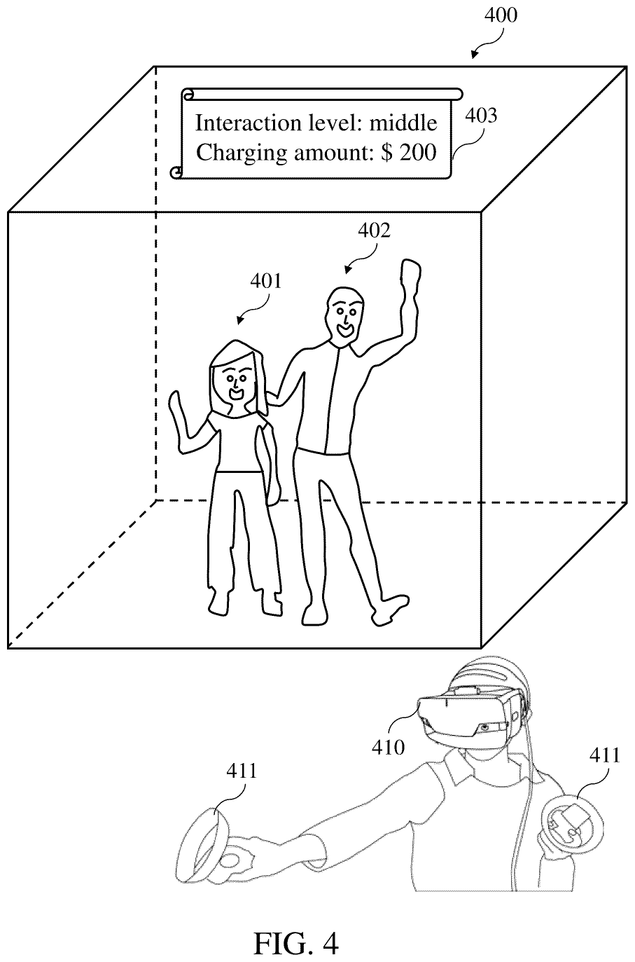

Please refer FIG. 4. FIG. 4 is a schematic view of interaction between a virtual avatar of a consumer and a virtual wax statue, according to an application of the present invention. In a condition that the server 120 generates virtual wax statues based on the portrait data of the celebrity through virtual imaging technology, generates the virtual scenes based on scene data, when the server 120 detects that a consumer logs in the digital wax museum platform 300, the server 120 drives the display device 410 to display the virtual scene, and the virtual wax statue, and a virtual avatar 401 of the consumer, and the server 120 permits a consumer to freely select the virtual wax statue and the virtual scene, for example, the consumer can select one of the generated virtual wax statue and the virtual scene, for example, the consumer selects the virtual wax statue 402 and the virtual scene 400. Next, the interaction level is set and transmitted to the server 120 through a virtual object 403 of the virtual scene 400, so that the server 120 allows the virtual avatar 401 to perform an interaction (such as action of patting head) with the virtual wax statue 402 based on interaction level. In actual implementation, based on the virtual avatar 401 and the virtual wax statue 402, the interaction level inputted from through the controller 411 can be used as parameters, and the generative AI model, parametric modeling, procedural modeling, real-time rendering engine, neural network or similar technology are used to enable the virtual avatar 401 and the virtual wax statue 402 to present different ways of interaction.

The server 120 executes the charging function and the profit-sharing function based on the smart contract deployed in the blockchain network, for example, when the charging function is executed, a charging amount is calculated based on the interaction level inputted by the consumer, the selected virtual wax statue 402 and the selected virtual scene 400. In actual implementation, each of the interaction level, the virtual wax statue and the virtual scene corresponds to an assigned sales amount, when the charging function is executed, a sales amount of all selected items are summed as the charging amount, the calculated charging amount is displayed on the virtual object 403. When the profit-sharing function is executed, a profit-sharing amount is calculated based on the calculated charging amount and a profit-sharing ratio, and the profit-sharing amount is provided to the celebrity who licenses the generated virtual wax statue through blockchain transaction; for example, the profit-sharing amount is transmitted to a wallet address stored in the genesis block, the genesis block records personal information of the celebrity to perform real-name identity. Therefore, the interaction between the virtual avatar 401 and the virtual wax statue 402 is completed in the virtual scene 400 and the profit-sharing mechanism is realized, so that the interactivity and economic benefits of marketing can be effectively improved.

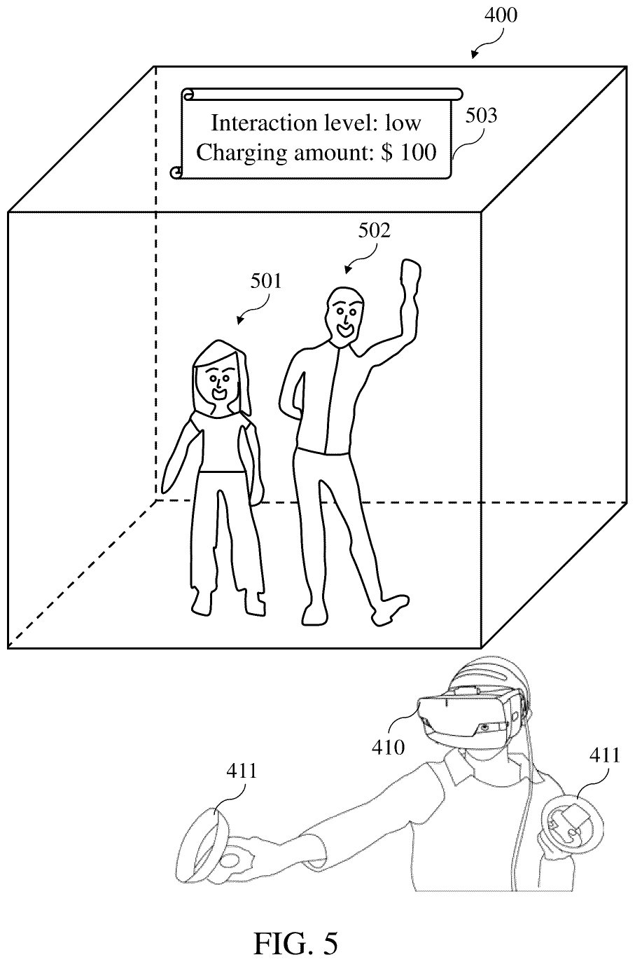

Please refer to FIG. 5. FIG. 5 is a schematic view of adjusting an interaction level, according to an application of the present invention. In a condition that the original interaction level is “middle”, the consumer can set the interaction level to be “low” by clicking virtual object 503. The server 120 receives the new interaction level being low, and make the virtual avatar perform an interaction with the selected virtual wax statue based on the new interaction level, as shown in FIG. 5, the interaction between the virtual avatar 501 and the virtual wax statue 502 is reduced, and the action posture becomes less intimate, for example, the distance between the virtual avatar 501 and the virtual wax statue 502 increases, the hand posture of the virtual wax statue 502 is changed to leaning back, and the movement of the virtual avatar 501 is less natural. Compared to the virtual avatar 401 and the virtual wax statue 402 shown in FIG. 4, a difference between the interaction level being adjusted to low and the interaction level originally being middle is clear.

According to above-mentioned contents, the difference between the present invention and the conventional technology is that, in the present invention, the display device can display the virtual scene, the virtual wax statue and the virtual avatar of the consumer, and the server connected to the display device executes the digital wax museum platform and serves as a node of the blockchain network; the server generates a virtual wax statue and a virtual scene and allows the consumer to select the virtual wax statue and the virtual scene, input the interaction level, make the virtual avatar perform an interaction with the virtual wax statue in the virtual scene based on interaction level; the charging amount and the profit-sharing amount are calculated through the smart contract of the blockchain technology. Therefore, the above-mentioned solution of the present invention can solve the conventional problem and achieve the technical effect of improving the interactivity and economic efficiency for marketing.

The present invention disclosed herein has been described by means of specific embodiments. However, numerous modifications, variations and enhancements can be made thereto by those skilled in the art without departing from the spirit and scope of the disclosure set forth in the claims.

What is claimed is:

1. A system of matching digital wax museum with marketing advertisement based on metaverse, comprising:
a display device, wherein after a consumer logs in a digital wax museum platform, the display device is configured to display at least one virtual scene, at least one virtual wax statue, and a virtual avatar of the consumer; and
a server, connected to the display device and configured to perform the digital wax museum platform and serve as one of nodes of a blockchain network, wherein the server comprises:
a non-transitory computer-readable storage medium configured to store computer readable instructions; and
a hardware processor, electrically connected to the non-transitory computer-readable storage medium and configured to execute the computer readable instructions to make the hardware processor execute:
generating the virtual wax statue through virtual imaging technology based on portrait data of a celebrity, and generating the virtual scene based on scene data;
allowing to select the generated virtual wax statue and the virtual scene, and receiving an interaction level, and making the virtual avatar perform an interaction with the selected virtual wax statue based on the received interaction level, wherein the interaction level comprises levels and at least one action corresponding to the levels;
building a genesis block to form a first block of the blockchain network based on a blockchain technology, connecting the first block to remote devices, which serve as the nodes of the blockchain network, to collectively execute a blockchain consensus mechanism to execute the blockchain network; and
deploying a smart contract in the blockchain network, wherein the smart contract comprises a charging function and a profit-sharing function, when the charging function is executed, a charging amount is calculated based on the received interaction level, selected virtual wax statue and the selected virtual scene, wherein when the profit-sharing function is executed, a profit-sharing amount is calculated based on the calculated charging amount and a profit-sharing ratio.

2. The system of matching digital wax museum with marketing advertisement based on metaverse according to claim 1, wherein the virtual wax statue comprises at least one of a static virtual wax statue and a dynamic virtual wax statue, and the interaction between the virtual avatar and the selected virtual wax statue comprises inputting the virtual avatar and the selected virtual wax statue to a generative AI model which is trained completely in advance, and outputting at least one interaction result through the generative AI model, wherein the at least one interaction result is dynamically adjusted based on at least one prompt inputted to the generative AI model.

3. The system of matching digital wax museum with marketing advertisement based on metaverse according to claim 2, wherein the hardware processor performs model establishment based on the interaction result output in response to the virtual avatar and the selected virtual wax statue, and prints out at least one 3D doll based on a model establishment result through a 3D printer.

4. The system of matching digital wax museum with marketing advertisement based on metaverse according to claim 2, wherein the hardware processor is configured to execute a web crawler to obtain the portrait data and the scene data, from at least one of a license database and internet, as training data to be inputted to the generative AI model.

5. The system of matching digital wax museum with marketing advertisement based on metaverse according to claim 1, wherein the at least one action of the interaction levels comprises at least one of a hand movement, a facial movement and a body movement for different intimacy levels, and the level is positively correlated with the intimacy level of the action.

6. A method of matching digital wax museum with marketing advertisement based on metaverse, applied to environment where a display device and a server are disposed, wherein the server performs a digital wax museum platform and serves as one of nodes of a blockchain network, and the method comprises:
generating at least one virtual wax statue through virtual imaging technology based on portrait data of a celebrity, and generating the at least one virtual scene based on scene data, by the server;
after detecting a consumer to log in the digital wax museum platform, driving the display device to display the virtual scene, the virtual wax statue, and a virtual avatar of the consumer, by the server;
allowing to select the generated virtual wax statue and the virtual scene, and receiving an interaction level, and making the virtual avatar to perform an interaction with the selected virtual wax statue based on the received interaction level, by the server, wherein the interaction level comprises levels and at least one action corresponding to the levels;
building a genesis block to form a first block of the blockchain network based on a blockchain technology, connecting the first block to remote devices which serve as nodes of the blockchain network, to collectively execute blockchain consensus mechanism to execute the blockchain network; and
deploying a smart contract in the blockchain network, by the server, wherein the smart contract comprises a charging function and a profit-sharing function, and when the charging function is executed, a charging amount is calculated based on the received interaction level, selected virtual wax statue and the virtual scene, wherein when the profit-sharing function is executed, a profit-sharing amount is calculated based on the calculated charging amount and a profit-sharing ratio.

7. The method of matching digital wax museum with marketing advertisement based on metaverse according to claim 6, wherein the virtual wax statue comprises at least one of a static virtual wax statue and a dynamic virtual wax statue, and the interaction between the virtual avatar and the selected virtual wax statue comprises inputting the virtual avatar and the selected virtual wax statue to a generative AI model which is trained completely in advance, and outputting at least one interaction result through the generative AI model, wherein the at least one interaction result is dynamically adjusted based on at least one prompt inputted to the generative AI model.

8. The method of matching digital wax museum with marketing advertisement based on metaverse according to claim 7, wherein the hardware processor performs model establishment based on the interaction result output in response to the virtual avatar and the selected virtual wax statue and prints out at least one 3D doll based on a model establishment result through a 3D printer.

9. The method of matching digital wax museum with marketing advertisement based on metaverse according to claim 7, wherein the hardware processor is configured to execute a web crawler to obtain the portrait data and the scene data, from at least one of a license database and internet, as training data to be inputted to the generative AI model.

10. The method of matching digital wax museum with marketing advertisement based on metaverse according to claim 6, wherein the at least one action of the interaction levels comprises at least one of a hand movement, a facial movement and a body movement for different intimacy levels, and the level is positively correlated with the intimacy level of the action.
